(19) United States
(12) Patent Application Publication
(10) Pub. No.: US 2010/0125781 A1
(43) Pub. Date: May 20, 2010

(54) PAGE GENERATION BY KEYWORD

(76) Inventor: Nicholas GADACZ, San Francisco, CA (US)

Correspondence Address: NIXON PEABODY, LLP, 401 9TH STREET, NW, SUITE 900, WASHINGTON, DC, 20004-2128, US

(21) Appl. No.: 12/274,855

(22) Filed: Nov. 20, 2008

(51) Int. Cl. G06F 17/00; G06F 17/30

(52) U.S. Cl. 715/234; 707/E17.108

(57) ABSTRACT

The dynamic creation of a web page based on frequently searched content of interest to users, which permits the creation of web pages focused on topics that will receive a high ranking by search engines, including a computer implemented method and a system for dynamically creating a computer readable web page with relevant user information, including receiving a search phrase that has been entered as a query into a search engine, parsing digital content of user generated records with a computing device to identify user generated content relating to the search phrase, aggregating the user generated content relating to the search phrase into a web page, and adding metadata to the webpage corresponding to the search phrase.

### BACKGROUND OF THE INVENTION

1. Field of the Invention

The invention relates to a method and system for dynamically creating a Web page with relevant user information.

2. Description of Related Art

As known and appreciated in the art, there are presently billions of Web pages on the Internet containing various content. Tools have been developed to allow the user to search these Web pages to obtain the various Web pages having content of interest. One way to locate the desired Web pages is to use a “search engine” which will search for Web pages having a particular keyword or keywords. Search engines typically have three components: a crawler (such as a robot, bot or automated site searcher), an index, and a software program which presents the results of the search to the user. The crawler automatically “crawls” from Web server to Web server and the sites hosted therein to gather URLs and other information such as the text of the page that the search engine can use in the searches for keywords. The information regarding the Web pages is stored in the search engine's databases as an index.

When a user seeking information from the Web types in a keyword(s) in a search field of the search engine, the search engine's software program then utilizes algorithmic functions and criteria to find keyword matches in the information stored in the index in a known manner. The software program then sorts through the results of the search and provides prioritized results to the user based on relevancy of the Web page to the query. Various search engine software programs differ in their methods used for determining a Web page's relevancy. For example, the software may view the “meta tag” of the page, include a counter for counting the number of keyword occurrences on the text of the page, and/or consider the Web page's popularity as well as other factors such as whether the Webmaster of the Web page has made special arrangements to have the Web page displayed as a result of the search.

Recently, user generated content, such as blogs and user reviews have become popular on the web. However, it is difficult to present search results to user generated content because frequently user generated content is not well organized by topic. Furthermore, it is known that one way search engine websites, such as www.google.com, rank a web page in a search results list is by how often users in the past have searched the terms of the page, i.e., a web page containing a large number of frequently searched terms or phrases will receive a high ranking.

### SUMMARY OF THE INVENTION

The present invention facilitates the dynamic creation of a web page based on frequently searched content of interest to users. Accordingly, the invention permits the creation of web pages focused on topics that will receive a high ranking by search engines.

Embodiments of the present invention relate to a computer implemented method for dynamically creating a computer readable web page with relevant user information, including receiving a search phrase that has been entered as a query into a search engine, parsing digital content of user generated records with a computing device to identify user generated content relating to the search phrase, aggregating the user generated content relating to the search phrase into a web page, and adding metadata to the webpage corresponding to the search phrase.

The embodiments also relate to a system for dynamically creating a computer readable computer readable web page with relevant user information, including means for receiving a search phrase that has been entered as a query into a search engine, means for parsing digital content of user generated records with a computing device to identify user generated content relating to the search phrase, means for aggregating the user generated content relating to the search phrase into a web page, and means for adding metadata to the webpage corresponding to the search phrase.

The computer implemented method for dynamically creating a computer readable web page with relevant user information may include generating a title of the web page that corresponds to the search phrase, wherein the receiving step includes receiving plural search phrases and filtering the search phrases to determine which search phrases are commonly searched, wherein the filtering step includes filtering an index of the user generated content, wherein the title of the webpage includes the search phrase, generating a web page address for the web page that corresponds to the search phrase, wherein the web page address for the web page includes the search phrase, wherein the user generated content includes information found on the World Wide Web, wherein the user generated content include other web pages and blogs, user reviews and user opinions, wherein the filtering step includes filtering out search phrases that rank highly in the search engine, and manipulating the metadata so that the web page receives a high ranking by the search engine.

The system for dynamically creating a computer readable web page with relevant user information may include means for generating a title of the web page that corresponds to the search phrase, wherein said means for receiving comprises receiving plural search phrases and filtering the search phrases to determine which search phrases are commonly searched, wherein said means for filtering comprises means for filtering an index of the user generated content, wherein the title of the web page that includes the search phrase, means for generating a web page address for the web page that corresponds to the search phrase, wherein the web page address includes the search phrase, wherein the user generated content includes information found on the World Wide Web, wherein the user generated content includes at least one of other web pages, blogs, user reviews and user opinions, wherein the means for filtering includes filtering out search phrases that rank highly in the search engine, and means for manipulating the metadata so that the web page receives a high ranking by the search engine.

### BRIEF DESCRIPTION OF THE DRAWINGS

The invention is described through a preferred embodiment and the attached drawings in which:

FIG. 1 is a block diagram of a computer architecture in accordance with the preferred embodiment of the invention including a search engine server;

FIG. 2 is a flowchart of a process for dynamically creating a web page with relevant user information; and

FIG. 3 is a schematic representation of an aggregating of user generated content to dynamically create a web page.

### DETAILED DESCRIPTION OF THE PREFERRED EMBODIMENT

Applicant has discovered that it would be advantageous to have a web page that can be dynamically created including well organized content that is directed to a new “hot” topic, and which can automatically receive a high ranking in the search results of a search engine.

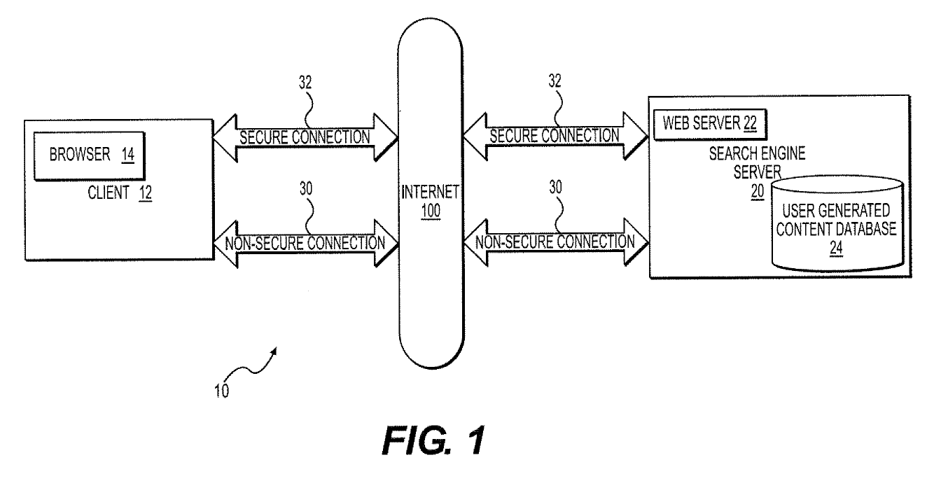

A preferred embodiment of a computer architecture of the invention is illustrated in FIG. 1. Search system 10 includes client computer 12, which executes browser application 14 that supports the HTTP protocol, or other appropriate protocols. Client computer 12 is connected, typically through an ISP (Internet Service Provider), to Internet 100 serving as a communication channel. For example, client computer 12 can be coupled to the ISP through a broadband connection such as ISDN (Integrated Services Digital Network), a cable modem, or a DSL (Digital Subscriber Line) connection. Search engine server 20 is also coupled to the Internet 100 in a known manner. Search engine server 20 executes, for example, a Web server control application 22, known as an HTTP server application, stored in a memory device. For example, public domain web server software applications from NCSA or APACHE can be used.

In the preferred embodiment, both of the client computer 12 and the search engine server 20 can be capable of communicating using a secure connection protocol, such as SSL or S-HTTP. For clarity, non-secure connections 30 and secure connections 32 are illustrated separately. However, typically, these connections will be effected over the same physical connection or communication channel, such as Internet 100. Further, search engine server 20 can have records of many Web pages stored in memory devices thereof, in the form of an index for example. Search engine server 20 also includes user generated content database 24 stored in the memory device thereof as described in detail below.

Client computer 12 can request a display of a Web page from search engine server 20 by issuing a URL request through Internet 100 to search engine server 20. For example, a user of client computer 12, i.e., a searcher, can enter a search query, including at least one query term(s) 40, into a form page displayed by browser 14. The browser interface can be populated with search results based on the search query. The user can select one or more of the search results to navigate to the content in a known manner. User generated content database 24 can include records of user generated content, e.g., blogs, user reviews, and user opinions, among other things. For example, user generated content database 24 can be an index of user generated content. The index of user generated content should be updated periodically to keep information on the most current “hot” topics included in user generated content database 24. The user generated content can be updated in user generated content database 24 in real time.

The results of a search query can be searched and displayed in browser 14 in ranked order of website title, website address, number of times a query term appears in the content of a webpage, relevancy to the search query, keywords or in any desirable manner.

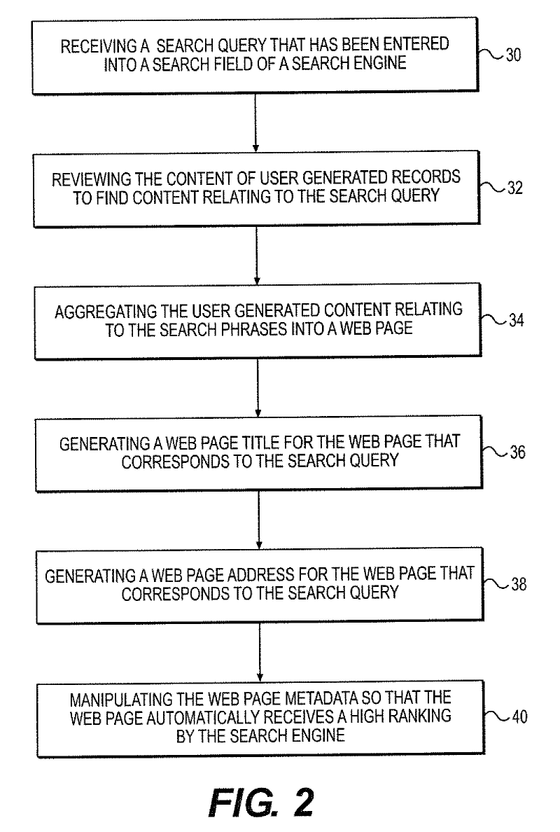

FIG. 2 illustrates a flowchart for dynamically creating a web page with relevant user information that can receive a high ranking by a search engine. Each step of FIG. 2 will be described in greater detail below. In step 30, a search query, including at least one query term, is received from a user. Next, in step 32, the content of user generated records is reviewed to find user generated content relating to the search query. Step 34 aggregates the user generated content relating to the search query into a web page, and step 36 generates a web page title that corresponds to or includes the search query term(s). In step 38 a web page address is generated for the web page that corresponds to or includes the search query term(s). After which, in step 40 the web page metadata is manipulated by incorporating the new title and adding keywords based on the search term to the web page metadata so that the web page automatically receives a high ranking in the search engine.

Additionally, receiving step 30 can include receiving plural search phrases and processing the search phrases to determine which search phrases are new and commonly searched. With respect to step 32, the reviewing step can include reviewing an index of the user generated content.

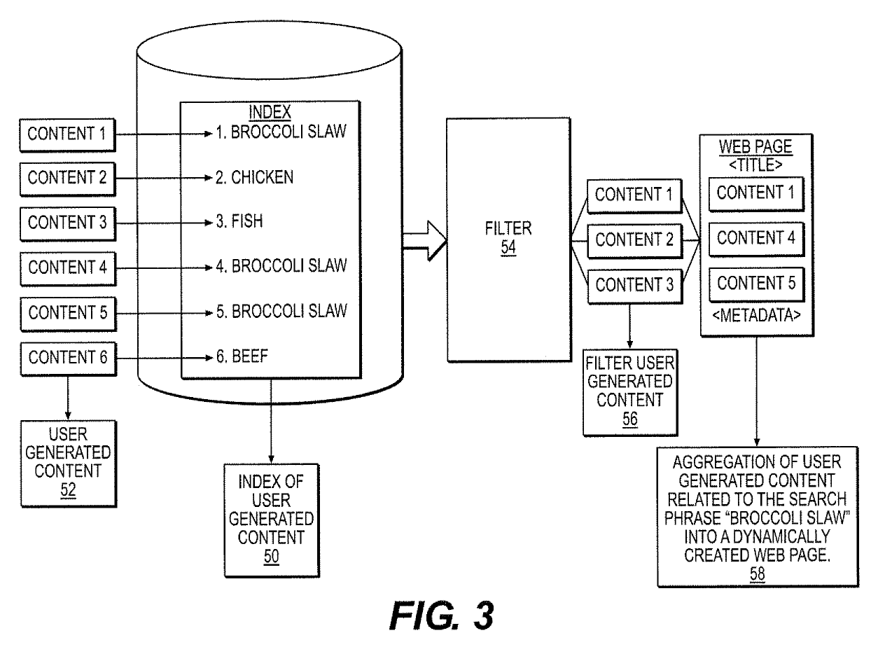

FIG. 3 schematically illustrates an index of user generated content 50, and the aggregation of the user generated content that has been indexed 52 into a dynamically created web page 58. For example, if a plurality of users begin to search the phrase “broccoli slaw”, i.e., a new food trend, the index of user generated content will be searched and the sections of the content corresponding to records in database 24 containing the phrase “broccoli slaw”, i.e., Content 1, Content 4 and Content 5 as seen in FIG. 3, can be aggregated to create a new web page 58. Thus, the text of the new page will of course have the phrase “broccoli slaw” in it many times, and will therefore be ranked highly in search results for similar terms for four reasons, 1) the phrase “broccoli slaw” is being frequently searched, 2) the web page has the phrase as a title (i.e., an H1 tag) or other metadata, 3) the web page has a high occurrence of the phrase in its text, and 4) the web page has the phrase in its address. It is preferable to ascertain whether “broccoli slaw” is a frequently used search term (e.g., the ranking is available from search engines), but is not included as the web page metadata and/or document title of any other documents. To accomplish this, a filter 54 is used to filter the phrase out of the keyword index 50 to determine if the phrase is already in the index 50. If not, then the phrase is a new term and it is appropriate to create a new web page based on the user generated content with the new phrase included in the title and associated with the web page metadata. Of course, the web page can be coded in HTML, and stored and displayed in a conventional manner.

Thus, the above described method and system in accordance with the embodiments of the present invention, as can now be fully appreciated, provides a very effective method for dynamically creating a web page of user generated content, and that will automatically receive a high ranking in the search results of a search engine.

The invention can be implemented over any type of communications channel, such as the Internet, a local area network (LAN), a wide area network (WAN), direct computer connections, or the like, using any type of communication hardware and protocols. Any type of hardware or combination of hardware can be used for various clients and servers. Accordingly, the term “computer” as used herein, refers to any type of computing device or data terminal, such as a personal computer, a portable computer, a dumb terminal, a thin client, a hand held device or any combination of such devices. The various clients and servers can be a single computer at a single location or multiple computers at a single or multiple locations. For example, a server may be comprised of a plurality of redundant computers disposed in co-location facilities at various locations to facilitate scalability. Any appropriate server or client software can be used and any communication protocols can be used. Communication can be accomplished over electric cable, fiber optic cable, any other cable, or in a wireless manner using radio frequency, infrared, or other technologies. Any interface can be used for selecting products for purchase. The various information can be stored in any format and thus the term “database” as used herein refers to any collection of information such as a database file, a lookup table, or the like.

The invention has been described through a preferred embodiment. However, various modifications can be made without departing from the scope of the invention as defined by the appended claims and legal equivalents.

1. A computer implemented method for dynamically creating a computer readable web page with relevant user information, comprising:
receiving a search phrase that has been entered as a query into a search engine;
parsing digital content of user generated records with a computing device to identify user generated content relating to the search phrase;
aggregating the user generated content relating to the search phrase into a web page; and
adding metadata to the webpage corresponding to the search phrase.

2. A method according to claim 1, further comprising:
generating a title of the web page that corresponds to the search phrase.

3. A method according to claim 1, wherein said receiving step comprises receiving plural search phrases and filtering the search phrases to determine which search phrases are commonly searched.

4. A method according to claim 1, wherein said filtering step comprises filtering an index of the user generated content.

5. A method according to claim 2, wherein the title of the webpage includes the search phrase.

6. A method according to claim 1, further comprising:
generating a web page address for the web page that corresponds to the search phrase.

7. A method according to claim 6, wherein the web page address for the web page includes the search phrase.

8. A method according to claim 1, wherein the user generated content includes information found on the World Wide Web.

9. A method according to claim 1, wherein the user generated content includes at least one of other web pages, blogs, user reviews and user opinions.

10. A method according to claim 3, wherein the filtering step comprises filtering out search phrases that rank highly in the search engine.

11. A method according to claim 1, further comprising:
manipulating the metadata so that the web page receives a high ranking by the search engine.

12. A system for dynamically creating a computer readable computer readable web page with relevant user information, comprising:
means for receiving a search phrase that has been entered as a query into a search engine;
means for parsing digital content of user generated records with a computing device to identify user generated content relating to the search phrase;
means for aggregating the user generated content relating to the search phrase into a web page; and
means for adding metadata to the webpage corresponding to the search phrase.

13. A system according to claim 12, further comprising:
means for generating a title of the web page that corresponds to the search phrase.

14. A system according to claim 12, wherein said means for receiving comprises means for receiving plural search phrases and means for filtering the search phrases to determine which search phrases are commonly searched.

15. A system according to claim 12, wherein said means for filtering comprises means for filtering an index of the user generated content.

16. A system according to claim 13, wherein the title of the webpage includes the search phrase.

17. A system according to claim 12, further comprising:
means for generating a web page address for the web page that corresponds to the search phrase.

18. A system according to claim 17, wherein the web page address for the web page includes the search phrase.

19. A system according to claim 12, wherein the user generated content includes information found on the World Wide Web.

20. A system according to claim 12, wherein the user generated content includes at least one of other web pages, blogs, user reviews and user opinions.

21. A system according to claim 14, wherein the means for filtering comprises means for filtering out search phrases that rank highly in the search engine.

22. A system according to claim 12, further comprising:
means for manipulating the metadata so that the web page receives a high ranking by the search engine.
